(19) United States
(12) Patent Application Publication
(10) Pub. No.: US 2021/0087400 A1
(43) Pub. Date: Mar. 25, 2021

(54) HYDROXYAPATITE/GELATIN COMPOSITE MATERIAL AND THE USE OF SAME, PARTICULARLY AS ARTIFICIAL IVORY, AND METHOD FOR PRODUCING SAME

(71) Applicant: Max-Planck-Gesellschaft zur Foerderung de Wissenschaften, e. V., Muenchen (DE)

(72) Inventors: Dieter FISCHER, Renningen (DE); Jochen MANNHART, Boeblingen (DE)

(21) Appl. No.: 16/629,835

(22) PCT Filed: Jul. 5, 2018
(86) PCT No.: PCT/EP2018/068208

§ 371 Date: Jan. 9, 2020

(30) Foreign Application Priority Data
Jul. 12, 2017 (DE) 102017115672.0

(51) Int. Cl. C08L 89/06; C08L 71/02; C08K 3/32; C08J 3/24

(52) U.S. Cl. CPC C08L 89/06; C08L 71/02; C08K 3/32; C08J 2389/04; C08K 2003/325; C08L 2312/00; C08J 3/24

(57) ABSTRACT

The invention relates to a method for producing a multi-purpose isotropic hydroxylapatite/gelatine composite material, involving at least the following steps: a) providing a suspension of powdered hydroxylapatite in a liquid medium selected from the group comprising a C1-C10 alcohol, particularly ethanol, another dispersing agent that can be mixed with water, water, and mixtures thereof; b) adding an aqueous solution of gelatine, preferably at a concentration of 5 to 25 wt. % gelatine, to the suspension; c) agitating the mixture at a predefined temperature for a predefined period of time, preferably in the region of 1 to 10 hours, until the liquid medium has been fully or partially evaporated; and d) optionally drying the product obtained in step c). In a specific embodiment, the method is characterised in that the product obtained in step c) or d) is additionally infiltrated with at least one aliphatic polyether in an additional step e1). In another specific embodiment, the method is characterised in that the product obtained in step c), d) or e1) is additionally brought into contact with at least one agent for crosslinking the gelatine chains, in step e2). A further aspect of the invention relates to the composite material produced using the method described above, and the use of same, particularly as artificial ivory.

### BACKGROUND OF THE INVENTION

The main component of the ivory is dentin: a mineralized tissue consisting of an organic matrix and an inorganic mineral. The dentin consists of 60-70% carbonate-containing hydroxyapatite (mineral), 20% collagen (matrix) and 10-20% water. During tooth growth, a special structure is formed between the collagen fibrils and the hydroxyapatite crystals. In addition, the dentin is still crossed with microchannels (tubules). The structural construction of dentin has meanwhile been thoroughly investigated and clarified (V. Jantou-Morris, M. A. Horton, D. W. McComb, Biomaterials 31 (2010), 5275-5286). The nucleation and growth of dentin and analog composite materials were also studied (Y. Wang, T. Azais, M. Robin, A. Vallee, C. Catania, P. Legriel, G. Pehau-Arnaudet, F. Babonneau, M M Giraud-Guille, N. Nassif, Nature Mater. 11 (2012), 724-733; K. Bleek, A. Taubert, Acta Biomater. 9 (2013), 6283-6321).

The main source of ivory are the tusks of the elephants. In addition, those of mammals such as mammoth, walrus, sperm whale, narwhal or hippo only play a minor role. Among other things, the ivory is used as a raw material for the production of art objects and as a covering for the white keys of keyboard instruments. Material properties such as the color (ivory color) and the light machining of the ivory are very important. Due to species protection, international ivory trade has been prohibited since 1989 (CITES agreement). Nevertheless, elephants are killed every day by poaching because of their tusks and the ivory is illegally sold.

Because of this situation, suitable replacement materials, in particular for instrument keys, have already been sought. Various organic polymers (plastics), some with mineral fillers (see e.g., U.S. Pat. No. 4,346,639, 1981; EP 0371939 A2, 1988; EP 457619 A, 1990), as well as ceramics (e.g., DE 19632409 A1, 1996) and also casein-based materials were described as replacement material (e.g., U.S. Pat. No. 4,447,268, 1980).

However, the organic polymers do not meet the technical requirements (surface quality, moisture absorption, thermal conductivity) of ivory instrument keys. With ceramic key coverings, the pore size and thermal conductivity can be set within certain limits, but they are heavier and do not show the desired moisture absorption.

So ivory is still insufficiently replaceable for instrument keys and there is still a need for a suitable replacement material.

Recently, there has also been interest in antibacterial key coverings. This additional requirement can also only be met by an artificial covering and such a material, which however consists of an acrylic resin with the disadvantages described above, is disclosed, e.g., in DE 19680977 B4 (2004) and CN 103483754 A (2012).

Species protection also requires that all other ivory products be replaced accordingly.

Against this background, therefore a main object of the invention is to provide new synthetic composite materials which can be used in particular as a replacement for natural ivory, but which also offer new uses in other fields of application.

This object is achieved according to the invention by the production method according to claim 1 and the isotropic hydroxyapatite/gelatin composite material obtainable therewith according to claim 14. Advantageous embodiments and applications of the invention result from the further claims and are explained in more detail in the following description.

### DESCRIPTION OF THE INVENTION

Components of the natural ivory are used in the synthesis approach according to the invention. Hydroxyapatite (Ca₅[Pa₄]₃OH) and gelatin are reacted directly in a solvent and concentrated with stirring/agitating. Gelatin is the product of the thermal hydrolysis of collagen and thus very similar to collagen, but is easier to implement chemically. In this synthesis, a swellable gelatin matrix is formed, which is stabilized by hydroxyapatite and whose properties can be adjusted.

More specifically, the manufacturing method according to claim 1 comprises at least the following steps:

a) providing a suspension of powdery hydroxyapatite in a (preferably polar) liquid medium which is selected from the group comprising a C₁-C₁₀ alcohol, in particular ethanol, another water-miscible dispersant, water and mixtures thereof;

b) adding an aqueous solution of gelatin, preferably in a concentration of 1 to 40, more preferably 5 to 25% by weight of gelatin, to the suspension;

c) agitating/stirring the mixture at a predetermined temperature for a predetermined period of time, typically in a range from 10 minutes to 24 hours (preferably 1 to 10 hours), until partial or complete evaporation of the liquid medium;

d) optionally drying the product obtained in step c).

The (polar) liquid medium is preferably not water, but rather a water-miscible dispersant, preferably a C₁-C₁₀ alcohol, in particular ethanol, or a mixture of such a dispersant with water. In a particularly preferred embodiment, this is an azeotropic mixture.

The aqueous solution of the gelatin added in step b) preferably contains a gelatin concentration of 1 to 40%, more preferred 5 to 25%, particularly preferred about 15%.

In principle, the selection of the gelatin used according to the invention is not particularly limited. However, the gelatin preferably has a high Bloom number, typically in a range from 50 to 350, preferably from 200 to 350, and a viscosity, which is typically in a range from 1 to 500, preferably from 10 to 150 mps, and a pH value which is typically in the range from 3 to 9, preferably from 4 to 7.

In step b), a heated gelatin solution (typically in a temperature range from 40 to 70° C.) is preferably added to a heated hydroxyapatite suspension (typically in a temperature range from 40 to 70° C.).

In step c), the reaction mixture is typically agitated/stirred for a period of from 10 minutes to 24 hours, preferably 2 to 10 hours, at a temperature of 40 to 200° C., preferably 50 to 60° C.

In a specific embodiment of this process, step c) is carried out at a temperature below the boiling point of the aqueous/organic liquid medium obtained after step b) (where applicable also below the boiling point of an azeotropic mixture).

The drying in step d) is affected in addition to the amount of material by temperature, water vapor content and ambient pressure. Preferably, it was conducted in air (1 bar), at 25° C. and approx. 45% rel. humidity. Vacuum drying is also possible.

The drying in step d) can be carried out completely (no further weight loss under standard conditions (1 bar, 25° C., 45% relative atmospheric humidity)) or only partially. Partial drying can be advantageous, for example, if the product is treated further, for example infiltrated.

Calcium phosphate/gelatin composite material syntheses from solution are described in the literature (eg T. Kollmann, P. Simon, W. Carrillo-Cabrera, C. Braunbarth, T. Poth, E. V. Rosseeva, R. Kniep, Chem. Mater. 22 (2010), 5137-5153; M. Chul Chang, W.H. Douglas, J. Tanaka, J. Mater. Sci.: Mater. Med. 17 (2006), 387-396).

However, in all publications known to the inventors, no use of a calcium phosphate/gelatin composite as an ivory replacement is known.

This is probably because the known composite materials are usually intended as bone replacement materials. Although the extracellular matrix of the bones and natural ivory have similar main components, namely hydroxyapatite and collagen, their structural setup and thus also essential physical properties differ significantly from one another. For example, the spatial arrangement of the extracellular matrix is adapted to the respective functionality of the bones and it is also able to embed the functional bone cells. An artificial material with this structure or these properties is usually anisotropic and hardly or not at all suitable for commercial use as an ivory replacement material.

In addition, in all publications known to the inventors, the calcium phosphate component is produced in situ. A Ca solution is reacted with a phosphate solution and the gelatin is mineralized. In contrast, according to the invention, powdery hydroxyapatite is used directly. In addition to being simpler to carry out, the use of powdered hydroxyapatite offers the advantages that there are no side reactions to other calcium phases, the components are relatively variable and interchangeable, and additional components are easily integrated. The Chinese patent CN 101239202 B shows a similar reaction procedure as shown here, however layered hydroxyapatite is used (explicitly produced) to produce a laminar structure (bone substitute material). The approach according to the invention, however, aims in the opposite direction. A random arrangement of the components in the product is deliberately created.

The aim of the synthesis is to produce a uniform composite material with suitable strength, which has isotropic properties and whose swellability, among other things, is adjustable. This can generally be achieved by the method according to the invention. The following aspects are particularly important for the synthesis.

On the one hand, the properties can be affected by the component ratio, on the other hand, the use of gelatin with a high Bloom number (corresponds to high mechanical strength in the gel) and highly concentrated gelatin solutions increase the strength of the product. In addition, it is advantageous to keep the duration or the temperature of the chemical reaction short or low, since the chain length of the gelatin molecules is increasingly degraded by hydrolysis with increasing duration/temperature. Furthermore, the pH should preferably be around the neutral point (pH=6-7).

This can done, e.g., by using azeotropic mixtures. For example, a mixture of water (4.4%) and ethanol (95.6%) boils azeotropically at 78.1° C. Thus, if, e.g., instead of hydroxyapatite suspended in water hydroxyapatite suspended in ethanol is reacted with the gelatin solution, the concentration of the suspension can be carried out at a lower temperature and faster. Furthermore, the gelatin is not further diluted (insoluble in ethanol), but the water content is successively reduced. Low water content, high Bloom number and rapid reaction at low temperature maintain longer gelatin molecule chains and thus lead to a more stable product. The hydroxyapatite crystals are embedded in the gelatin matrix with no preferred direction, which leads to isotropic product properties.

The product synthesized by the method according to claim 1 shows an increased water absorption compared to natural ivory. This is undesirable for some applications. The swellability can be reduced by thermal treatment, but at the same time the gelatin matrix also decomposes, which at a temperature >150° C. already leads to a brown color in the product.

Preferred embodiments of the synthesis process according to the invention therefore include a further process step with which the water absorption of the product is reduced or water already absorbed is removed again.

One possibility for this is infiltration with an aliphatic polyether, preferably a polyethylene glycol (PEG). PEG (HO(CH₂CH₂O)ₙ—H) is available in a wide variety of molecular weights, is water-soluble, non-toxic, and has an antibacterial effect.

The crude product according to the invention can easily be infiltrated with PEG/water mixtures or PEG. The material initially stores water, which is then exchanged for PEG and thus leads to a durable, impregnated product. This infiltration can also be used to adjust the water absorption by means of different molecular weights of the PEG polymers used.

For this purpose, completely (no further weight loss under standard conditions) or only incompletely dried material can be used, whereby the infiltration also simultaneously solidifies the material.

When infiltrated with a PEG/water mixture, the material also remains dimensionally stable, since at the same time the water absorption is significantly reduced. Infiltration with pure water, on the other hand, leads to a soft, plastic (soft rubber-like) product.

As a rule, the aliphatic polyether used, in particular PEG, has a molar mass in the range from 100 to 10,000,000 g/mol, preferably from 400 to 4000 g/mol.

The infiltration treatment according to the invention typically comprises at least one of the following steps:

Contacting the product obtained in step c) or d) of claim 1 with a medium containing a mixture of polyether/water for a predetermined period, preferably in a range from 1 hour to 1 week, and optionally subsequent drying; or

Contacting the product obtained in step c) or d) of claim 1 with an anhydrous medium comprising or consisting of an aliphatic polyether for a predetermined period, preferably in a range from 1 hour to several weeks.

A specific process variant is characterized in that the contacting with the polyether takes place under reduced pressure or under vacuum. The specific process conditions are not particularly critical and can easily be optimized by the skilled artisan in routine tests. For example, the contacting can be effected at a pressure of 10-500 mbar or 20-200 mbar for a period of 1 to 48 h, preferably 1-24 h.

A preferred embodiment of this method comprises at least the following steps:

e1a) contacting the product obtained in step c) or d) of claim 1 with a medium containing a mixture of polyether/water for a predetermined period, preferably in a range from 1 hour to 1 week, and

e1b) subsequently exchanging the medium for an anhydrous medium comprising or consisting of an aliphatic polyether and contacting the product obtained after step e1a) with the anhydrous polyether for a predetermined period of time, preferably in a range from 1 hour to several weeks.

In the course of the infiltration treatment, the color of the product also changes from white to ivory, the respective color intensity depending on the material used and the duration. This treatment thus makes the artificial ivory according to the invention particularly advantageous as a piano key covering.

A further possibility for the aftertreatment of the crude product obtained according to the invention is contacting with at least one agent for crosslinking the gelatin chains (curing). The water absorption can also be reduced in this way.

This at least one crosslinking agent is preferably selected from the group comprising complex-forming metal salts, aldehydes, ketones, epoxides, isocyanates, carbodiimide and enzymes, and is particularly preferably a complex-forming metal salt.

The complex-forming metal salt is generally not particularly limited. However, it is preferably selected from the group consisting of the salts of aluminum, chromium, iron, titanium, zirconium, molybdenum, and in particular alums, e.g., potassium alum, chromium alum.

The acid groups of the amino acids in the gelatin chains can be cross-linked by metal complex formation by means of treatment with a complex-forming metal salt and thus the swellability and water absorption can also be reduced or regulated.

The crosslinking can also be combined with an infiltration treatment as described above.

Accordingly, a specific embodiment of the method according to the invention is characterized in that the product obtained in step c), d) or e1) as described above is further contacted in step e2) with at least one agent for crosslinking the gelatin chains.

In a typical embodiment, the product obtained in step c), d) or e1) is contacted for a predetermined period, preferably from 1 hour to 1 week, with the crosslinking agent, preferably a solution of a complex-forming metal salt, and then, optionally after removal the crosslinking agent, e.g., the metal salt solution, and washing, the product is dried.

A further specific embodiment of the method according to the invention is characterized in that only a partial area of the product obtained in step c), d) or e1) is contacted with the crosslinking agent and the gelatin matrix is crosslinked only in this partial area.

This may be achieved, for example, by effecting superficial contacting by means of repeated application of the crosslinking agent, e.g., a brush or cloth on the surface of the composite material.

Another specific embodiment of the method according to the invention is characterized in that the crude product according to the invention is infiltrated and contacted with the crosslinking agent in one step. In this variant, steps e1) and e2) take place simultaneously. In a preferred process variant, the product is treated with a PEG/aqueous (preferably about 1%) potassium alum solution.

Another aspect of the present invention relates to the products obtainable by the process according to the invention, i.e. isotropic hydroxyapatite/gelatin composite materials.

After the steps a)-d) of the process according to the invention described above, a white, solid product is initially produced which is break-resistant, moisture-absorbent, machinable, temperature-resistant and, under certain conditions, also flexible. By using the same components as in ivory, this product is very close to the natural product and there is also the option of varying the synthesis procedure, e.g., to optimize the desired material properties through incorporations/embeddings or chemical reactions.

For example, as described above, an aliphatic polyether can be embedded in the material and/or the gelatin chains can be crosslinked. The incorporation of the polyether and/or the treatment with suitable crosslinking agents lead, among other things, to the creation of an ivory-colored product. Furthermore, the incorporation of the polyether and/or the treatment with suitable crosslinking agents also improves the feel of the product. As already mentioned at the beginning, this is very important for certain applications, in particular for piano keys, and in this respect the products according to the invention offer a clear advantage over conventional ivory replacement products for the production of synthetic key coverings.

In some specific embodiments, the isotropic hydroxyapatite/gelatin composite material according to the invention is therefore characterized in that it contains an aliphatic polyether, in particular PEG, embedded in the hydroxyapatite/gelatin matrix and/or crosslinked gelatin chains, in particular acid groups of the amino acids in the gelatin chains crosslinked via metal complexes.

The material according to the invention can also be crosslinked or otherwise modified only in a partial area, e.g., on the surface.

The optionally incorporated aliphatic polyether, in particular the PEG, typically has a molar mass in the range from 100 to 10,000,000 g/mol, preferably from 400 to 4000 g/mol.

The composite material according to the invention may further comprise one or more additives, in particular pigments, dyes and phosphors, materials for marking materials, salts, metal particles, polymers, e.g., polyethylene glycol, and their derivatives (such as UV-curable ones), glasses, fibers (cellulose, polypropylene, carbon, hollow glass fiber, ZnO nanofibers, hemp fibers) or antimicrobial components, e.g., TiO₂, Ag nanoparticles.

In a typical embodiment, the isotropic hydroxyapatite/gelatin composite material according to the invention is characterized in that it contains hydroxyapatite particles with dimensions in the nanometer range, typically in the range from approx. 5 to 1000 nm, preferably 10 to 900 nm, more preferably 10 to 500 nm, for example 10 to 100 nm or 50 to 500 nm, randomly embedded in an amorphous gelatin matrix.

In a preferred embodiment, the isotropic hydroxyapatite/gelatin composite material according to the invention is characterized in that it contains hydroxyapatite needles with dimensions in the nanometer range, typically approximately 10×50 nm, randomly embedded in an amorphous gelatin matrix.

In a specific embodiment, the composite material according to the invention has the following composition:

50 to 100% by weight of hydroxyapatite/gelatin matrix with a hydroxyapatite/gelatin ratio of 1:1 to 10:1, preferably 2:1 to 4:1, in particular approximately 3:1, 0 to 30% by weight %, preferably 1 to 10 wt.-%, of residual liquid medium, and

optionally 0.5 to 50% by weight, preferably 1 to 25% by weight, of polyether.

As already mentioned, the composite material according to the invention offers a variety of possible uses due to its advantageous properties, in particular as an artificial ivory, but also in other fields.

According to the invention, black key coverings can also be produced for the first time by incorporating a black pigment, which also have the advantageous properties of ivory. So far, keys made of dark wood such as ebony or plastic keys have been used for this.

Therefore, a further aspect of the invention relates to preferred uses of this material, for example for the production of key coverings for keyboards in general, handles/grip inserts, e.g., for sports equipment, tools and knives, watches, model components, toys, office utensils, writing utensils, dishes, kitchen appliances, clothing accessories, sanitary items, pharmaceuticals, electronic components, building materials, construction materials, lamps, interiors for cars, jewelry items, coatings, e.g., on wood, glass, plastics or metals, e.g., for interior furnishings, eyeglass frames or more generally as a moisture-regulating material and as a plastic substitute.

The embedding of fibers also offers the possibility of optimizing properties such as porosity, surface roughness and stability. In addition, certain fibers can also be removed again from the material with a suitable solvent.

Plastic articles of all kinds can thus be produced, for the production of which no petroleum or plasticizer is required.

Products with a multilayer structure can also be realized.

### BRIEF DESCRIPTION OF THE FIGURES

FIG. 1 shows photographs of an isotropic composite material according to the invention;

FIG. 1A shows the hydroxyapatite/gelatin composite raw material after air drying;

FIG. 1B shows the material after cutting, polishing and PEG infiltration.

FIG. 2 shows an SEM image of the material surface with apatite crystals in the gelatin matrix.

FIG. 3 shows TEM images of the composite material on different scales;

FIGS. 3A and 3B show embedded hydroxyapatite needles (typical dimension approx. 10×50 nm);

FIG. 3C shows embedded non-acicular hydroxyapatite particles (with sizes up to 1000 nm).

FIG. 4 shows IR spectra of the raw material (1), treated with PEG-400/water (2) or with PEG/potassium alum (3).

FIG. 5 shows X-ray powder diffractograms of the raw material (1), treated with PEG-400/water (2) or with PEG/potassium alum (3).

FIG. 6 shows the Raman data of a comparison of natural ivory (1) and the composite material (2) according to the invention.

The following examples are intended to explain the invention in greater detail, but without restricting it to the respective particular parameters and conditions.

### EXAMPLE 1

### Preparation of a Hydroxyapatite/Gelatin Composite Material

An aqueous gelatin solution (10 g in 75 ml deionized H₂O) was added to 30 g of hydroxyapatite, suspended in 75 ml of ethanol or water, and concentrated in a beaker while agitating/stirring at approx. 50° C. The mass was then completely dried in air.

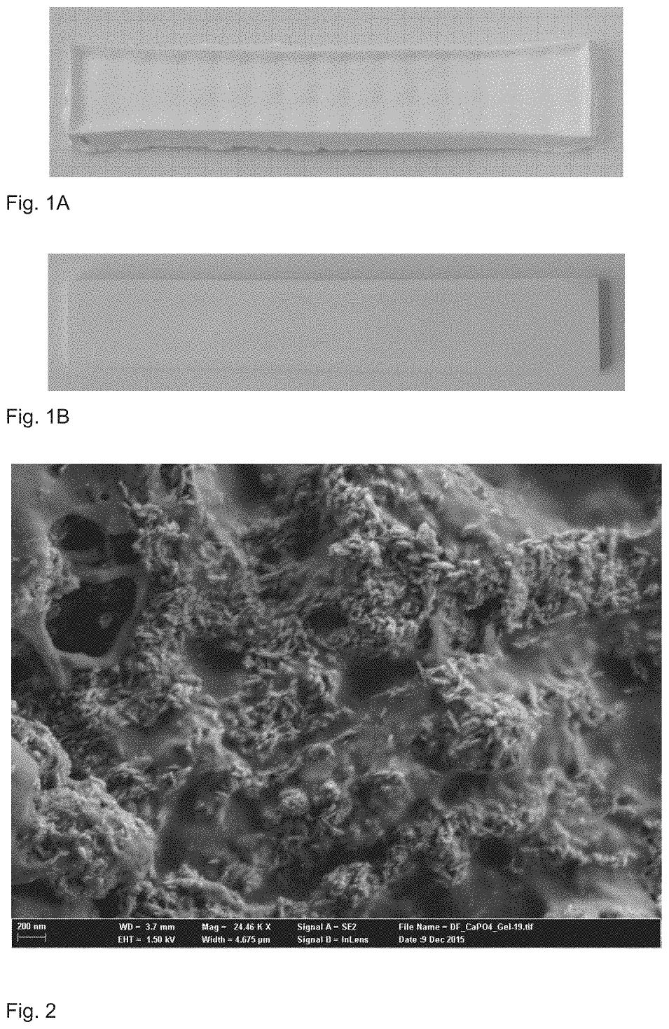

FIG. 1A shows the hydroxyapatite/gelatin composite raw material obtained as above after drying in air.

### EXAMPLE 2

### Preparation of a Hydroxyapatite/Gelatin Composite Material with Embedded PEG

27 g of gelatin were introduced into 200 g of deionized water and left to stand (swell) overnight (16 hours). This mass was then heated to 55° C. in a water bath, whereby it becomes completely liquid. In a second beaker, 90 g of hydroxyapatite were suspended in 210 g of ethanol at 55° C. The aqueous gelatin solution was then slowly added to this suspension with stirring and concentrated at 55° C. for 5 hours. The white mass was poured into a plastic container, air dried for about 3 hours and was then removed from the container. The product was then further dried first in air (5 days between perforated plates) and then in an oven for 24 hours at 100° C. The material obtained can be machined.

The white product was then infiltrated first with a mixture (1:1) of PEG-400/H₂O for 2 days and then with pure PEG-400 for 6 days. The ivory-colored material obtained in this way was then cut and polished accordingly.

FIG. 1B shows the material after cutting, polishing and PEG infiltration.

The process steps for the storage of PEG are independent of the raw material production and can be freely combined.

The direct infiltration of PEG-400 into still moist raw material also provided a stable product. This process variant offers the advantage of faster implementation.

### EXAMPLE 3

### Treatment of a Hydroxyapatite/Gelatin Composite with a Crosslinking Agent

In various process variants of the treatment with a crosslinking agent (e.g., cut/polished) hydroxyapatite/gelatin composite material was placed in a 1% aqueous potassium alum solution, a 1:1 mixture consisting of PEG-400 and 1% aqueous potassium alum solution, a 1% aqueous glyoxal solution, or a 1:1 mixture consisting of PEG-400 and 1% aqueous glyoxal solution for 2 days and then dried in air.

The process steps for crosslinking are independent of the raw material preparation or already effected infiltration and can be freely combined.

### EXAMPLE 4

### Preparation of Pigmented Hydroxyapatite/Gelatin Composite Materials

The respective composite material was produced analogously to Example 1 or 2. In deviation from the protocol there, either 0.3 g of solid FeCl₂, 0.1 g of dioxazine violet (pigment violet 37, C₄₀H₃₄N₆O₈), 0.4 g of phthalocyanine green (heliogen green PG7, CuC₃₂Cl₁₆₋ₙHₙN₈), 1 g of HAN-Blue (BaCuSi₄O₁₀), or 0.5 g nano-Ag (20-40 nm) were added to the hydroxyapatite suspension.

### EXAMPLE 5

### Preparation of a Black Hydroxyapatite/Gelatin Composite Material

60 g of hydroxyapatite and 36 g of bone black (Kremer pigments, Germany) were suspended in 180 g of ethanol at 60° C. An aqueous gelatin solution heated to 60° C. (30 g in 230 g deionized H₂O) was then added and the mixture was concentrated in a beaker with stirring at approx. 60° C. for 6 hours. The black mass was poured off and then dried completely in air. The product was then tempered at 100° C. for a further 14 hours and then processed as desired.

By pouring different colored masses together after concentrating in a mold, colored patterns/grains/inlays were also obtained.

### EXAMPLE 6

### Characterization of a Hydroxyapatite/Gelatin Composite Material According to the Invention

Hydroxyapatite/gelatin composite material obtained according to Example 1, 2 or 3 was characterized in more detail using various microscopic and spectroscopic examination methods.

A. Scanning Electron Microscopy (SEM)

The scanning electron microscope image was taken on a flat sample of the composite material using a DSM 982 Gemini microscope from Zeiss (Germany) in a high vacuum (secondary electron detector, 24,500× magnification, see scale).

FIG. 2 shows an SEM image of the material surface of the raw material: the apatite crystals in the gelatin matrix are visible.

B. Transmission Electron Microscopy (TEM)

The high-resolution transmission electron microscopy images were taken on a sample of the composite material that had been ultrasonically thinned out using a JEOL device ARM200F at 200 kV (JEOL Co. Ltd) equipped with a cold field emission gun and CETOR image correction (CEOS Co, Ltd.) in high vacuum. The length scale is given in the images.

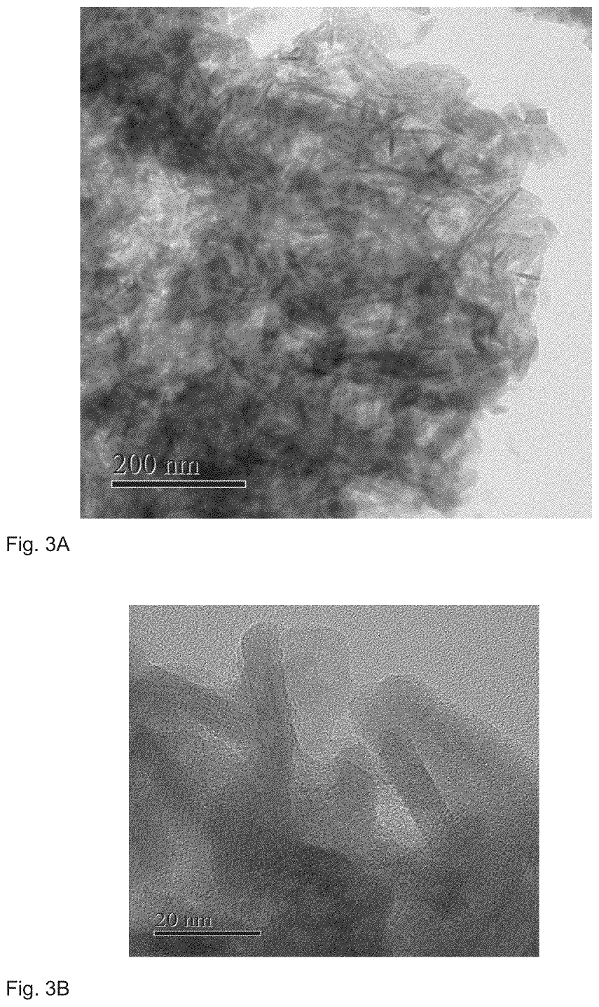

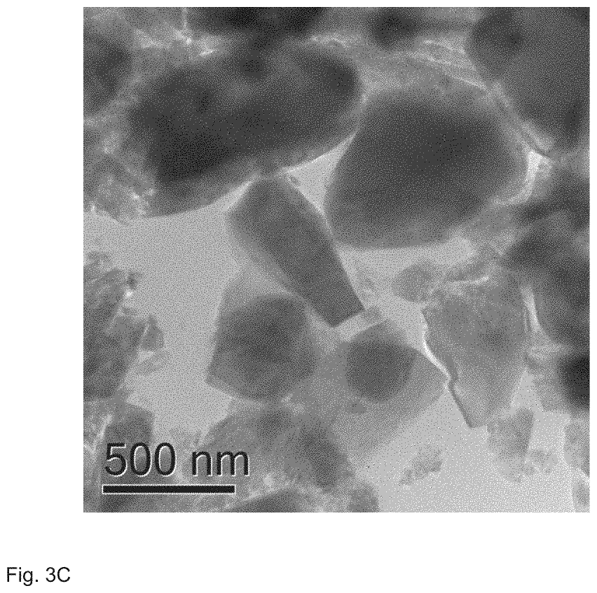

FIG. 3 shows TEM images with parts of the raw material in different magnifications: Apatite crystals are visible isotropically embedded in an amorphous gelatin matrix. 3A and 3B show embedded hydroxyapatite needles (typical dimension approx. 10×50 nm) and FIG. 3C shows non-needle-shaped hydroxyapatite particles with sizes up to 1000 nm.

C. Infrared Spectroscopy (IR)

The IR spectra were recorded on a flat sample of the composite material using a Perkin Elmer spectrometer BX II FT-IR from Perkin Elmer (USA) equipped with an ATR unit (Smith Detection Dura-Sample IIR diamond). The transmission spectra in the range of the wave number from 400 to 4000 cm⁻¹ have a resolution of 1 cm⁻¹ and their intensities have been scaled.

FIG. 4 shows IR spectra of the raw material (1), treated with PEG-400/water (2) or with PEG/potassium alum (3). The bands of the raw material as well as the bands of the corresponding infiltrated components are visible in all cases.

D. X-Ray Powder Diffractometry

The X-ray powder diffractograms were recorded on a flat sample of the composite material with a diffractometer in Bragg-Brentano geometry (Cu-Kα radiation) in reflection with a PIXcel 3D detector from PANalytical (Netherlands). The diffractograms were measured in the diffraction angle range from 10 to 90° in 2-theta and their intensities were scaled.

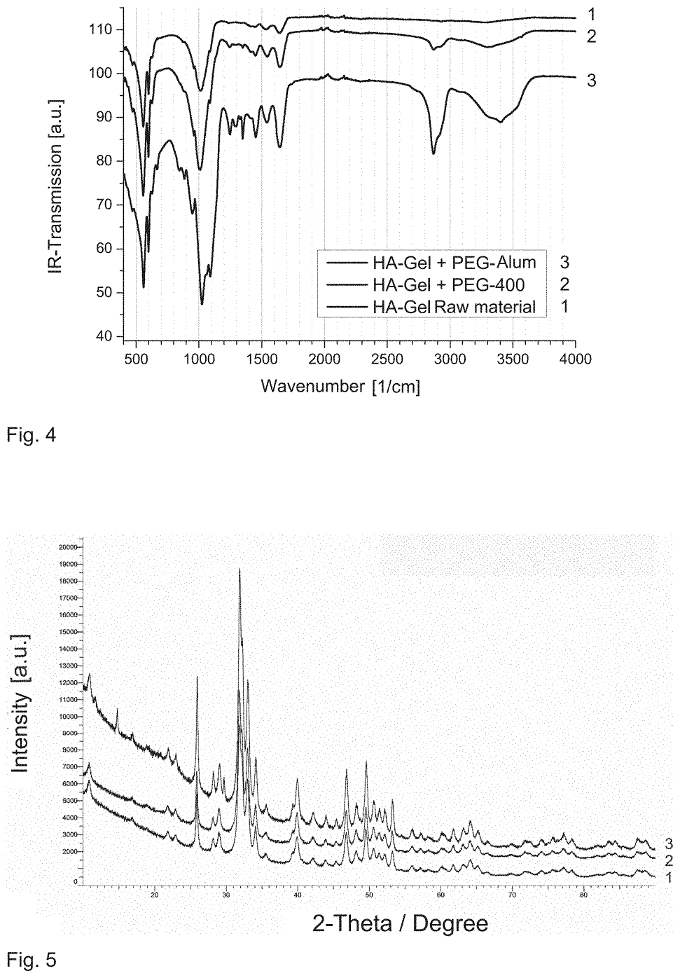

FIG. 5 shows X-ray powder diffractograms of the raw material (1), treated with PEG-400/water (2) or with PEG/potassium alum (3). In all cases, the reflections of the hydroxyapatite are visible as well as for sample 3 additionally those of potassium alum.

E. Raman Spectroscopy

The Raman spectra were recorded with a laser microscope Raman spectrometer (iHR 550 spectrometer; BXFM microscope) from HORIBA (Germany) with confocal geometry. The laser beam (wavelength 532 nm, power: 10 mW) was focused on a flat sample in air using an objective (100×).

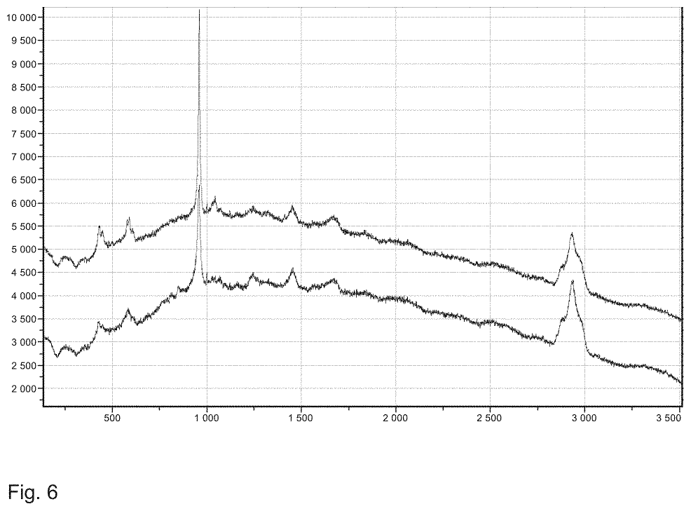

FIG. 6 shows the corresponding Raman data: lower curve: natural ivory (1), upper curve raw material hydroxylapatite/gelatin composite (2).

This comparison demonstrates that the Raman spectra of both materials are almost identical.

The preferred embodiments and features of the invention described in the present application can be combined with one another.

Although the invention has been described with reference to certain embodiments, it will be apparent to those skilled in the art that various changes can be made and equivalents can be used as substitutes without departing from the scope of the invention. Accordingly, the invention is not intended to be limited to the exemplary embodiments disclosed, but is intended to include all exemplary embodiments that fall within the scope of the appended claims. In particular, the invention also claims protection for the subject and the features of the subclaims independently of the claims referred to.

1. A method for producing an isotropic hydroxyapatite/gelatin composite material, which comprises at least the following steps:
a) providing a suspension of powdery hydroxyapatite in a liquid medium selected from the group consisting of a C₁-C₁₀ alcohol, another water-miscible dispersant, water and mixtures thereof;
b) adding an aqueous solution of gelatin, in a concentration of 1 to 40% by weight of gelatin, to the suspension to provide a mixture;
c) agitating/stirring the mixture at a predetermined temperature for a predetermined period of time until partial or complete evaporation of the liquid medium; and
d) optionally drying the product obtained in step c).

2. The method according to claim 1, wherein step c) is carried out at a temperature below a boiling point of the liquid medium obtained after step b).

3. The method according to claim 1, wherein a product obtained in step c) or d) is further infiltrated in an additional step e1) with at least one aliphatic polyether.

4. The method according to claim 1, wherein a product obtained in step c) or d) is further contacted in a step e2) with at least one crosslinking agent for crosslinking gelatin chains.

5. The method according to claim 4, wherein the at least one crosslinking agent is selected from the group consisting of complex-forming metal salts, aldehydes, ketones, epoxides, isocyanates, carbodiimide and enzymes.

6. The method according to claim 5, wherein the complexing metal salt is selected from the group consisting of salts of aluminum, chromium, iron, titanium, zirconium, and molybdenum.

7. The method according to claim 3, further comprising at least the following steps:
e1a) contacting the product obtained in step c) or d) of claim 1 with a medium containing a mixture of poly ether/water for a predetermined period, and
e1b) subsequently exchanging the medium for an anhydrous medium comprising an aliphatic polyether and contacting a product obtained after step e1a) with the aliphatic polyether for a predetermined period of time.

8. The method according to claim 3, wherein the contacting with the polyether is carried out under reduced pressure or under vacuum.

9. The method according to claim 4, wherein the product obtained in step c), or d) is contacted for a predetermined period, with a crosslinking agent and then, optionally after removing the at least one crosslinking agent and washing, the product is dried.

10. The method according to claim 4, wherein only a partial area of the product obtained in step c) or d) is contacted with the at least one crosslinking agent and the gelatin matrix is crosslinked only in the partial area.

11. The method according to claim 10, wherein a superficial contact is effected by repeated application of the at least one crosslinking agent on a surface of the composite material.

12. The method according to claim 3, wherein the at least one aliphatic polyether has a molecular weight in a range from 100 to 10,000,000 g/mol.

13. The method according to claim 3, wherein the at least one aliphatic polyether is a polyethylene glycol.

14. An isotropic hydroxyapatite/gelatin composite material, obtainable by the method according to claim 1, which contains hydroxyapatite particles with dimensions in a nanometer range randomly embedded in an amorphous gelatin matrix.

15. The composite material according to claim 14, wherein the hydroxyapatite particles represent or comprise hydroxyapatite needles with dimensions in the nanometer range.

16. An isotropic hydroxyapatite/gelatin composite material, obtainable by the process according to claim 3, which contains an aliphatic polyether embedded in the gelatin matrix and/or crosslinked gelatin chains, wherein acid groups of amino acids in the gelatin chains are crosslinked via metal complexes.

17. The composite material according to claim 16, wherein the aliphatic polyether has a molecular weight in a range from 100 to 10,000,000 g/mol.

18. The composite material according to claim 16, wherein the aliphatic polyether is a polyethylene glycol.

19. The composite material according to claim 15, which has the following composition:
50 to 100% by weight of hydroxyapatite/gelatin matrix with a hydroxyapatite/gelatin ratio of 1:1 to 10:1,
0 to 30% by weight of residual liquid medium, and
optionally 0.5 to 50% by weight of polyether.

20. The composite material according to claim 14, which further comprises one or more additives selected from the group consisting of pigments, dyes, phosphors, materials for marking materials, salts, metal particles, polymers, glasses, fibers, and antimicrobial components.

21. The composite material according to claim 14, which is ivory-colored.

22. An artificial ivory comprising the composite material according to claim 14.

23. The composite material according to claim 14, which is configured for use as at least a part of key coverings for keyboards, handles/grip inserts, watches, model components, toys, office utensils, writing utensils, dishes, kitchen appliances, clothing accessories, sanitary items, pharmaceuticals, electronic components, building materials, construction materials, lamps, interiors for cars, jewelry items, coatings, eyeglass frames, a moisture-regulating material and a plastic substitute.

24. The composite material according to claim 14, which has the following composition:
50 to 100% by weight of hydroxyapatite/gelatin matrix with a hydroxyapatite/gelatin ratio of 1:1 to 10:1,
0 to 30% by weight of residual liquid medium, and
optionally 0.5 to 50% by weight of polyether.

25. The composite material according to claim 15, which further comprises one or more additives selected from the group consisting of pigments, dyes, phosphors, materials for marking materials, salts, metal particles, polymers, glasses, fibers and antimicrobial components.

26. The composite material according to claim 15, which is configured for use as at least a part of key coverings for keyboards, handles/grip inserts, e.g., for sports equipment, tools and knives, watches, model components, toys, office utensils, writing utensils, dishes, kitchen appliances, clothing accessories, sanitary items, pharmaceuticals, electronic components, building materials, construction materials, lamps, interiors for cars, jewelry items, coatings on wood and other materials such as glass, plastics or metals, e.g., for interior fittings, eyeglass frames, or as a moisture-regulating material and as a plastic substitute.

27. An artificial ivory comprising the composite material according to claim 15.

28. An artificial ivory comprising the composite material according to claim 16.

29. The method according to claim 3, wherein the product obtained in step e1) is further contacted in a step e2) with at least one agent for crosslinking the gelatin chains.

30. The method according to claim 29, wherein the at least one crosslinking agent is selected from the group consisting of complex-forming metal salts, aldehydes, ketones, epoxides, isocyanates, carbodiimide and enzymes.

31. The method according to claim 30, wherein the complexing metal salt is selected from the group consisting of salts of aluminum, chromium, iron, titanium, zirconium and molybdenum.

32. The method according to claim 29, wherein only a partial area of the product obtained in step e1) is contacted with the at least one crosslinking agent and the gelatin matrix is crosslinked only in the partial area.

33. The method according to claim 32, wherein a superficial contact is effected by repeated application of the at least one crosslinking agent on a surface of the composite material.

34. The method according to claim 29, wherein the aliphatic polyether has a molecular weight in a range from 100 to 10,000,000 g/mol.

35. The method according to claim 29, wherein the aliphatic polyether is a polyethylene glycol.

36. The method according to claim 3, wherein a product obtained in step e1) is contacted for a predetermined period with a crosslinking agent, and then, optionally after removing the at least one crosslinking agent and washing, the product is dried.

37. The method according to claim 36, wherein the at least one crosslinking agent is a solution of a complexing metal salt.

38. The method according to claim 1, wherein the C₁-C₁₀ alcohol is ethanol.

39. The method according to claim 6, wherein the complexing metal salt is an alum.

40. The method according to claim 31, wherein the complexing metal salt is an alum.
